(19) United States
(12) Patent Application Publication
(10) Pub. No.: US 2025/0182114 A1
(43) Pub. Date: Jun. 5, 2025

(54) PAYMENT MANDATES FOR MERCHANT INITIATED TRANSACTIONS

(71) Applicant: STRIPE, INC., South San Francisco, CA (US)

(72) Inventors: Sarath Surendranath, Aldie, VA (US); Himanshu Jaju, London (GB)

(21) Appl. No.: 18/526,945

(22) Filed: Dec. 1, 2023

(51) Int. Cl. G06Q 20/40

(52) U.S. Cl. CPC G06Q 20/4014

(57) ABSTRACT

A system includes: a processing circuit; and memory storing instructions that, when executed by processing devices include the processing circuit, cause the processing devices to: receive a payment mandate setup request from a merchant of a plurality of merchants; create a payment provider-independent payment mandate setup request based on the payment mandate setup request; receive a payment provider identifier identifying a payment provider from among a plurality of payment providers; transmit the payment provider-independent payment mandate setup request to the payment provider identified by the payment provider identifier, the payment provider-independent payment mandate setup request include a payment mandate identifier; receive approval of the payment mandate setup request from specified payment provider, the approval include the payment mandate identifier; and store a payment mandate for a customer of the merchant in association with the merchant and the payment provider, the payment mandate being associated with the payment mandate identifier.

### BACKGROUND

Electronic payment processing technology enables the automatic and convenient processing of commercial transactions between consumers and merchants, where payment providers support the transfer of funds from consumers to merchants. In some circumstances, consumers engage in repeated transactions with various merchants, such as in the case of a subscription (e.g., which may incur periodic fees, such as a monthly fee) and in the case where users may purchase different items over time as desired (e.g., saving payment information for use in subsequent purchases from an online store).

The above information disclosed in this Background section is only for enhancement of understanding of the present disclosure, and therefore it may contain information that does not form the prior art that is already known to a person of ordinary skill in the art.

### SUMMARY

The present disclosure is directed to payment mandates for merchant-initiated transactions, substantially as shown in and/or described in connection with at least one of the figures, as set forth more completely in the claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram depicting the implementation of electronic payment mandates according to one embodiment of the present disclosure.

FIG. 2A is a flowchart depicting a method for creating a payment mandate, according to one embodiment of the present disclosure.

FIG. 2B is a sequence diagram depicting communications, according to one embodiment of the present disclosure, between a merchant, an electronic payment transaction platform, and a payment provider to set up a payment mandate.

FIG. 3A is a flowchart depicting a method for processing a payment mandate, according to one embodiment of the present disclosure.

FIG. 3B is a sequence diagram depicting communications, according to one embodiment of the present disclosure, between a merchant, an electronic payment transaction platform, and a payment provider when a merchant initiates a payment using a saved, existing payment mandate.

FIG. 4A is a flowchart depicting a method for revoking a payment mandate, according to one embodiment of the present disclosure.

FIG. 4B is a sequence diagram depicting communications, according to one embodiment of the present disclosure, between a merchant, an electronic payment transaction platform, and a payment provider when a merchant initiates a revocation of a payment mandate.

FIG. 4C is a sequence diagram depicting communications, according to one embodiment of the present disclosure, between a merchant, an electronic payment transaction platform, and a payment provider when a payment provider initiates a revocation of a payment mandate.

FIG. 5 is a block diagram illustrating a high-level network architecture of a computing system environment for operating a processing system according to embodiments of the present disclosure.

FIG. 6 is a block diagram illustrating a representative software architecture, which may be used in conjunction with various hardware architectures as described herein.

FIG. 7 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Merchants face a complex business environment with respect to handling payments from customers. Payment methods used by various customers may include personal checks, automated clearinghouse (ACH) transfers, credit cards (over multiple different payment networks), electronic payment methods, mobile payment services (e.g., Apple Pay®, Alipay®, PayPal®, or WeChat Pay®), mobile carrier billing (e.g., via providers of mobile telephony services), buy-now-pay-later payments, voucher-based payments such as payments made at convenience stores (e.g., Konbini payments), and the like. Furthermore, the payment methods available and/or customarily used by consumers may differ based on geography, where different local payment providers may dominate different geographic markets or jurisdictions. Engaging in regional or global commerce therefore requires a merchant to be able to handle payments from a wide variety of customers that may have different preferences or access to payment methods. In a case where M different merchants need to be able to accept N different payment methods, this may require M times N different customized integrations between the front-end electronic store operated by the merchants and the N different back-end payment provider systems.

Some aspects of embodiments of the present disclosure relate to electronic payment hubs or electronic payment transaction platforms, implemented by computer systems, that simplify the process of coordinating between merchants and payment providers. A merchant may choose to integrate their front-end electronic store with an electronic payment transaction platform, which then provides access to the N different payment providers. This greatly reduces the engineering effort required on the part of the merchant to provide their customers with a large range of payment options.

Electronic payment hubs also provide payment providers with improved access to processing transactions for customers. Without using an electronic payment hub, a payment provider may have needed to convince individual merchants to sign up and to spend the engineering effort needed to integrate with that payment provider. In contrast, integrating with the electronic payment transaction platform provides the payment provider with access to all of the merchants who use the same electronic payment hub, such that those merchants' customers can make payments through those integrated payment providers.

As such, electronic payment hubs provide payment providers, merchants, and their customers with improved experiences in processing electronic payments (e.g., electronic commerce over the internet).

A payment mandate is an agreement between a customer and a merchant that authorizes the merchant to create and pay for orders on behalf of the customer, without requiring a separate customer authorization for each payment (e.g., without requiring the customer to approve each payment individually). For example, a payment mandate to a video streaming service may authorize the streaming service to collect monthly payments from the customer, without requiring the customer to authorize payment each time the payment is charged. As another example, there may be goods where there is a delay between placing and order and delivery of the order, in which case a customer and a merchant may form an agreement that payment for the order is to be collected at the time of delivery (or at some time after delivery) rather than at the time the order is placed. Payments that are processed while a customer is involved in manual authorization may be referred to as “online” payments, whereas merchant-initiated payments that are processed automatically without customer involvement may be referred to as “offline” payments.

When processing an offline payment, the payment provider may automatically (without human involvement) perform various checks to determine whether the payment will succeed. For example, some payments may be made by deducting from an account balance (e.g., an internal wallet balance maintained by the payment provider or a deduction from a linked bank account) or by charging against credit (e.g., a credit card or other deduction against a line of credit). In either case, the charge may fail due to, for example, insufficient funds in the account balance or insufficient credit. As another example, a charge may also fail due to the revocation of the payment mandate (e.g., termination of the agreement that authorizes the charges). The revocation of the payment mandate may be triggered by a customer, the merchant (e.g., in response to the customer's cancelling the subscription), or the payment provider (e.g., based on detecting fraud committed by the customer account or by the merchant account).

Different payment providers may provide different mechanisms (e.g., application programming interfaces (APIs)) for implementing this functionality or may provide only partial functionality (e.g., support for a limited set of features). This difference in implementation can cause confusing experiences for customers. For example, a customer may be able to make single online payments using a first payment provider, but the customer may need to switch to using a second payment provider to make recurring offline payments because the first payment provider does not support payment mandates or only supports a limited subset of functionality for offline payments that are not sufficient to implement recurring payments. As another example, a first payment provider may allow cancellation or revocation of the payment mandate through a user interface provided via the merchant (e.g., on the merchant's website) whereas another payment provide may only allow revocation of the payment mandate through an interface provided by the payment provider (e.g., on the payment provider's website). The different application programming interfaces offered by different payment providers can also substantially increase the engineering burden on the electronic payment hub in developing integrations with each separate payment provider and translating the functionality offered by the payment provider to the services exposed to the customer through the merchant integrations.

Therefore, aspects of embodiments of the present disclosure relate to computerized systems and methods for implementing interfaces for managing automatic payment mandates between customers and merchants with a plurality of different payment providers. In more detail, various aspects of embodiments of the present disclosure relate to solving problems arising from the use of computer systems to implement electronic payment platforms.

One problem arising from the use of an electronic payment platform that supports payment mandates is ensuring that all payment providers that are connected to the electronic payment platform support the functionality needed to the payment mandates. For example, implementing a payment mandate includes a setup process for a merchant to confirm with a specified payment provider that the associated customer is registered and approved for implementing a payment mandate (e.g., that an account exists for the customer and has a sufficient balance or credit). The resulting payment mandate then should be stored and invoked by the merchant such that the merchant initiates a charge to the customer at an appropriate time, where the merchant and the payment provider ensure that the payment mandate is being invoked appropriately (e.g., that the payment mandate has not been revoked and that the transaction is within the scope of the payment mandate) and that the customer account associated with the payment mandate still holds sufficient balance or credit to pay the specified payment amount. Furthermore, revocations of the payment mandate may originate from various parties such as the customer, the merchant, or the payment provider, and therefore aspects of embodiments of the present disclosure relate to propagating information between the involved parties regarding revocations of payment mandates.

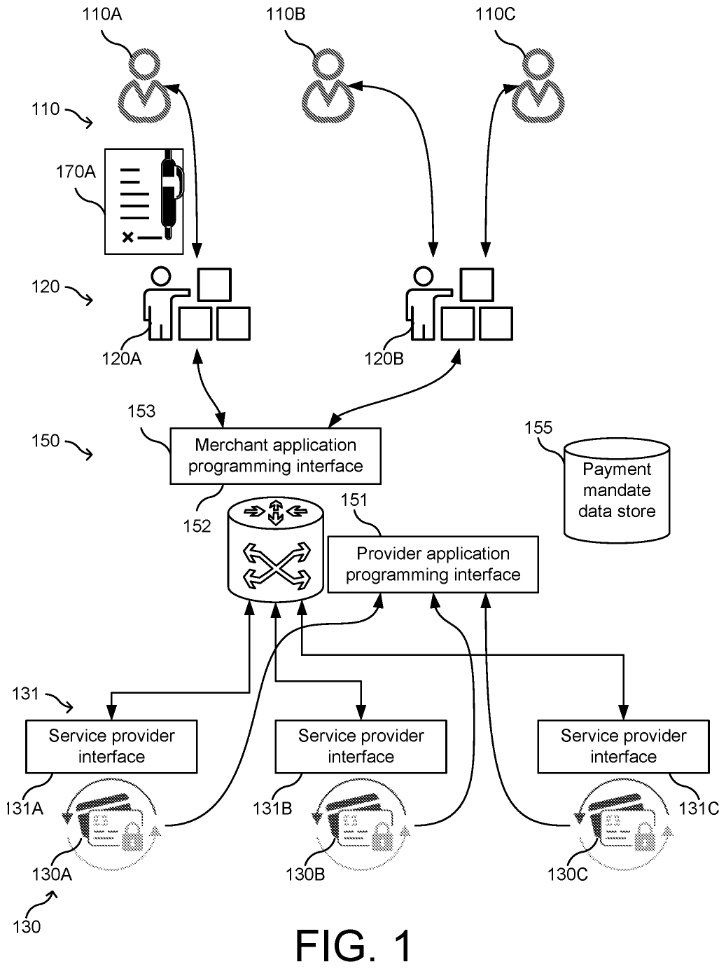

Aspects of embodiments of the present disclosure address the problem of delivering consistent payment mandate services to customers, regardless of the payment provider that the customer chooses to use for the payment mandate, because the supported payment providers comply with a standardized or uniform interface for interacting with payment mandates, such as setting up new payment mandates, invoking or initiating payments using payment mandates, and revoking payment mandates as described in more detail below (e.g., each of the payment providers 130 implements a uniform SPI 131, as shown and descried in FIG. 1).

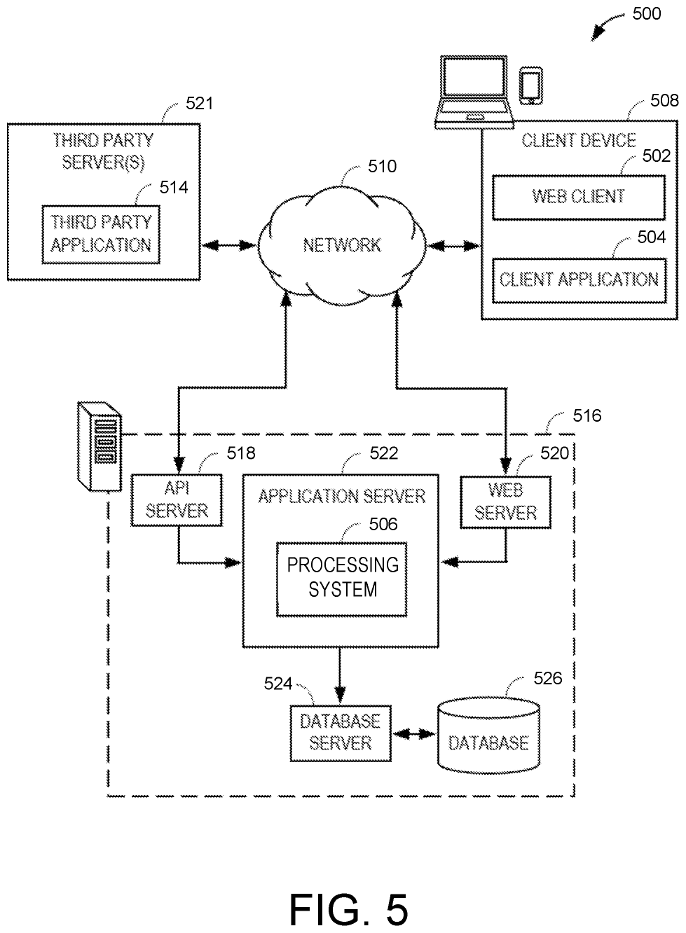

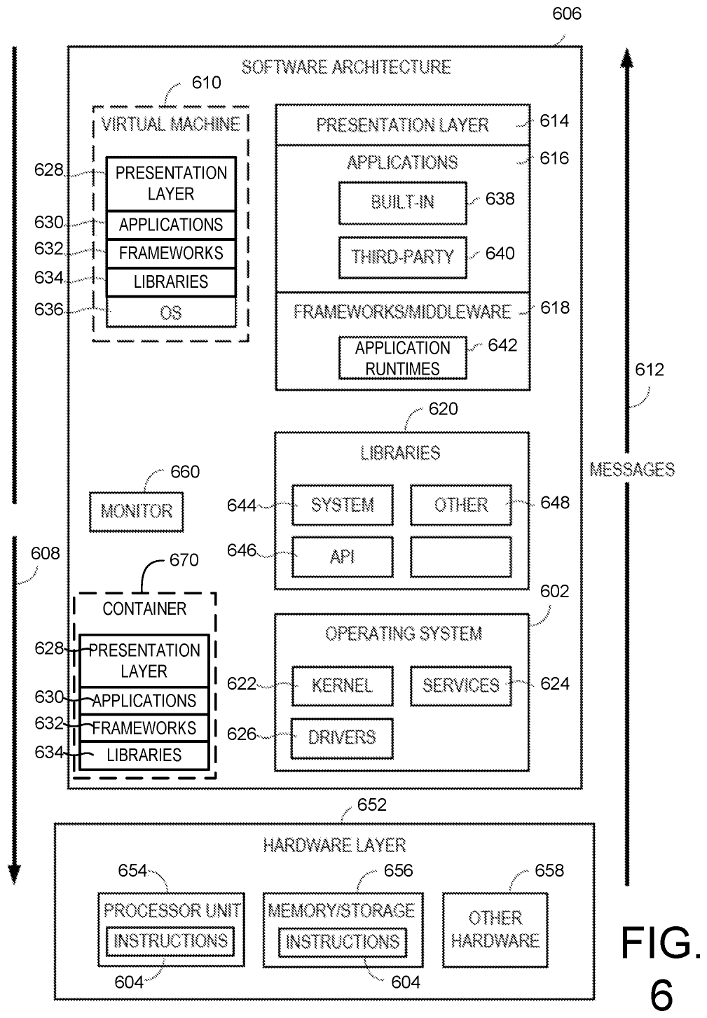

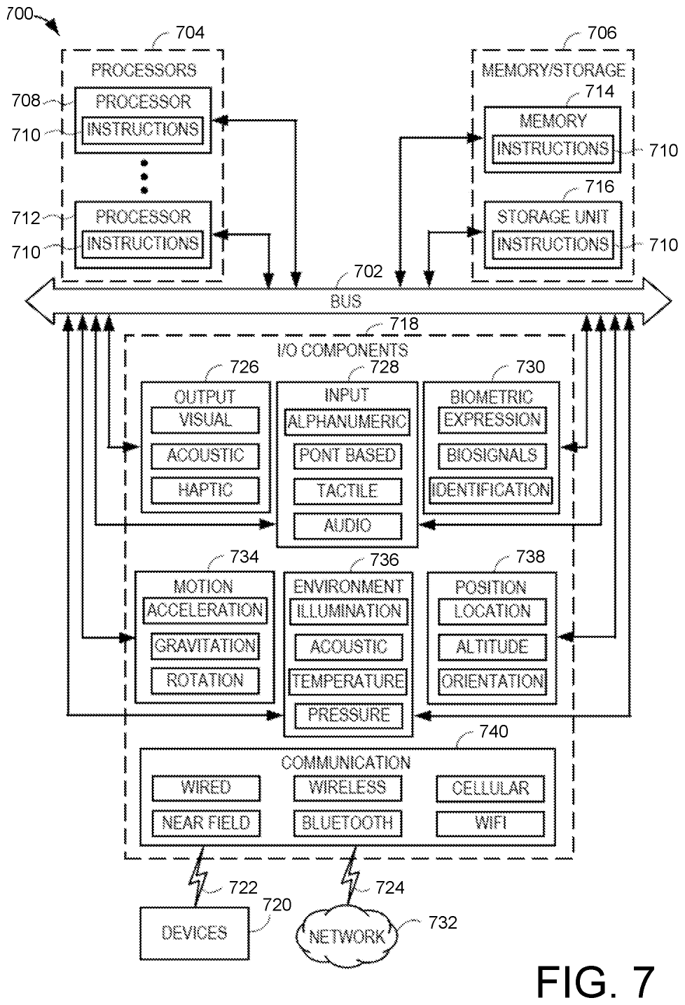

FIG. 1 is a schematic block diagram depicting the implementation of electronic payment mandates according to one embodiment of the present disclosure. The example of FIG. 1 depicts users or customers 110 (e.g., 110A, 110B, 110C), merchants 120 (e.g., 120A, 120B), and payment providers 130 (e.g., 130A, 130B, 130C) based on their respective roles in the implementation of payment mandates with respect to an electronic payment transaction platform 150. Each of these parties involved in the registration and processing of payment mandates is implemented using one or more computer systems, such as those described in more detail below with respect to FIG. 5, FIG. 6, and FIG. 7.

To address the uniformity of services provided by the payment providers, some aspects of embodiments of the present disclosure relate to a service provider interface (SPI) 131 (e.g., 131A, 131B, 131C) which specifies a uniform collection of interfaces to be provided by the payment providers 130. The uniform SPI implemented by the supported payment providers 130 may be defined by, for example, the electronic payment transaction platform 150 or by a standards setting organization. Because each of the payment providers 130 implements the same SPI, the electronic payment transaction platform 150 can interact with each of the payment providers 130 in the same way, such as by transmitting a message regarding a payment mandate setup in a standardized format (e.g., a format common to all of the payment providers 130 implementing the SPI) and transmitting the message to the appropriate payment provider (e.g., based on a selection made by the customer when requesting to create a payment mandate through an interface provided by a merchant 120, such as a website or mobile app operated by the merchant).

In some embodiments of the present disclosure, the electronic payment transaction platform 150 further provides a provider application programming interface (API) 151 for payment providers 130 to transmit messages to the electronic payment transaction platform 150 and a merchant application programming interface 153 for merchants 120 to transmit messages to the electronic payment transaction platform 150.

The service provider interface 131 may define one or more communication protocols for managing payment mandates that are processed by the payment providers 130. In some embodiments, the service provider interface is provided over hypertext transfer protocol (HTTP) or hypertext transfer protocol secure (HTTPS) in accordance with an architectural style such as representational state transfer (REST) protocol. The messages transmitted through the SPI 131, the provider API 151, and the merchant API 152 over HTTP or HTTPS may be encoded in any of a variety of data formats such as JavaScript Object Notation (JSON), extensible markup language (XML), and the like. As another example, the SPI 131, the provider API 151, and the merchant API may also include interfaces using other protocols such as remote procedure calls (RPCs) and other message passing interfaces over different network protocols (e.g., other than HTTP or HTTPS).

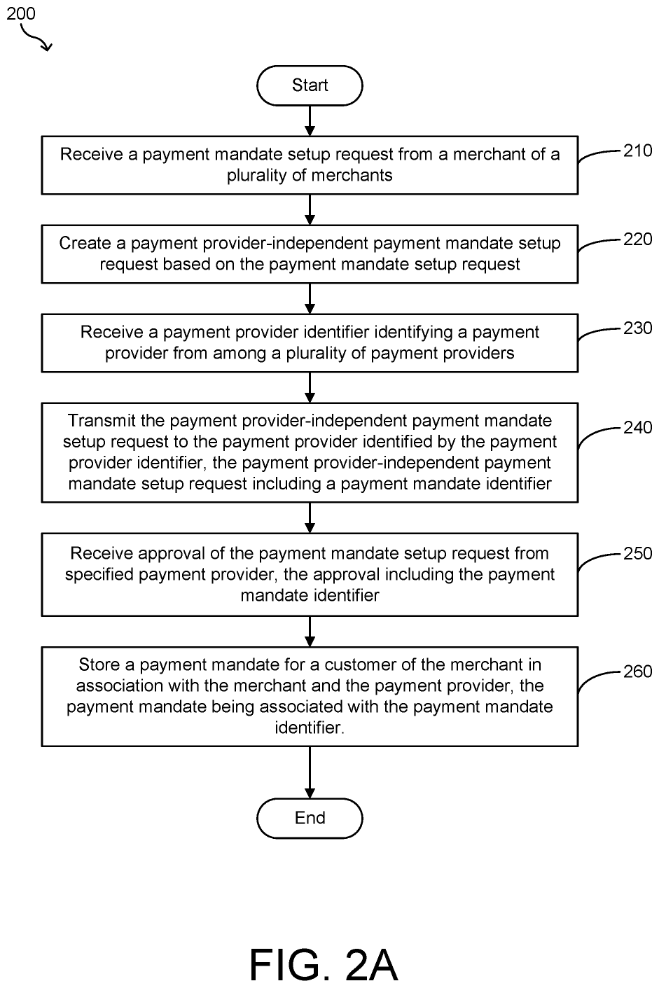

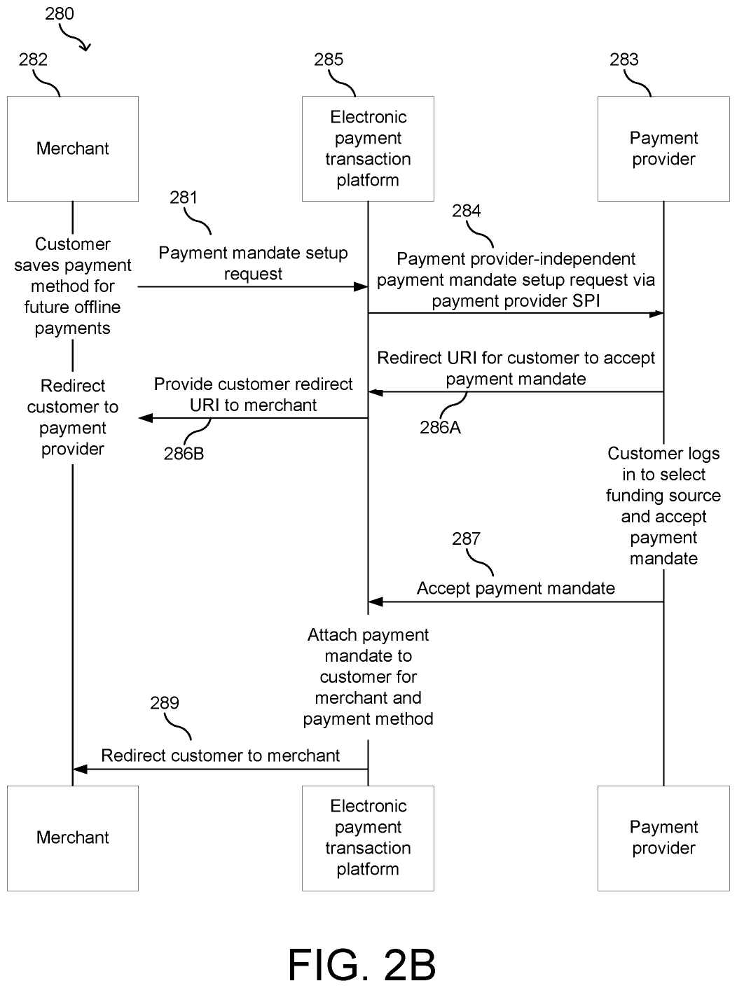

FIG. 2A is a flowchart depicting a method 200 for creating a payment mandate, according to one embodiment of the present disclosure. In various embodiments of the present disclosure, the method 200 and equivalents thereof are implemented using one or more processing circuits of computing system environments with software and hardware architectures such as those described below with respect to FIG. 5, FIG. 6, and FIG. 7. FIG. 2A will be described in more detail below from the perspective of a computing system environment associated with the electronic payment transaction platform 150 described above with respect to FIG. 1. FIG. 2B is a sequence diagram 280 depicting communications, according to one embodiment of the present disclosure, between a merchant 282, a payment provider 283, and an electronic payment transaction platform 285. FIG. 2B illustrates a sequence diagram that corresponds to the steps in the FIG. 2A flowchart. The steps of FIG. 2A will described together with FIG. 2B.

At 210, the computing system environment of the electronic payment transaction platform 150 receives a payment mandate setup request 281 from a merchant 282 from among a plurality of merchants 120. This payment mandate setup request 281 is created when a customer chooses to grant a payment mandate to a merchant. In the example shown in FIG. 1, the first customer 110A chooses to create a payment mandate (the first payment mandate 170A shown in FIG. 1) with the first merchant 120A. This payment mandate 170A, once granted, allows the first merchant 120A to charge the first customer 110A for goods or services without requiring the first customer 110A to separately authorize each charge at the time that the charge is made. Payment mandates are useful in circumstances such as recurring payments (e.g., subscription services where a monthly or annual fee is automatically charged through a payment mandate), irregular payments of varying amounts (e.g., goods and services charged on a per-purchase or per-use basis, such as online retail goods, restaurants, rideshare services, lodging services, and the like), and circumstances where a payment may be authorized ahead of time and charged at a later date, such as on delivery (e.g., a purchase where goods are made to order and may not be delivered until weeks or months after placing the order).

In more detail, the electronic payment transaction platform 150 may provide a software library (e.g., a JavaScript library) and/or a specification for accessing the merchant API 152. The software library provided by the electronic payment transaction platform 150 may include software that generates a portion of a computer user interface that can be presented to a customer through a computer user interface managed by the merchant. As one example, a merchant may operate a retail website (either directly or using an electronic commerce platform or other website hosting service), and the software library may provide a widget or other portion of a user interface that manages a payment process (e.g., a virtual shopping cart checkout process.

For example, a JavaScript software library may hook into a specified node in a checkout web page and populate that node with user interface controls for paying for the goods and/or services offered by the merchant. As another example, a software library to be integrated into a mobile application may similarly generate a user interface component that is integrated into the mobile application for the user to select a payment provider.

The customer interacts with the user interface component to provide information for handling the payment process or checkout process. In circumstances where payment mandates are appropriate for the business operated by the merchant (e.g., subscription services, irregularly recurring payments, and circumstances where there may be a delay between order placement and order delivery), the user interface component may include an indication that a payment mandate will be created or provide the customer with an option to create a payment mandate. Such an option may be designated with language such as “Enter payment details now to be charged at the time of delivery” or “Save payment details for later use” or “Automatically charge me this amount every month” or “I authorize {Merchant} to charge me each month until I cancel this service or until {Merchant} discontinues this service.” An indication that the customer has agreed to such an option or requirement may be interpreted as the customer's intention to grant the merchant a payment mandate to make future charges.

Accordingly, the payment mandate setup request 281 received at 210 via the merchant API 152 indicates that a payment mandate is to be created between a specified customer and a specified merchant. The payment mandate setup request may also include constraints, such as a termination date (or expiration date) of the payment mandate and charging limits (e.g., per-transaction or total).

At 220, the electronic payment transaction platform 150 creates a payment provider-independent payment mandate setup request 284 based on the payment mandate setup request 281. For example, the payment provider-independent payment mandate setup request may be structured as a JSON object having specified fields describing the constraints of the payment mandate, a customer identifier, a merchant identifier, and the like. The payment provider-independent payment mandate setup request 284 may follow a structure specified by the payment provider SPI 131, such that the same payment provider-independent payment mandate setup request 284 can be transmitted to any payment provider 130 that implements a SPI 131 that complies with the specifications (e.g., specifications defined by the electronic payment transaction platform 150 or by a standards setting organization). The electronic payment transaction platform 150 may also create a payment mandate identifier (e.g., a unique identifier) that identifies the particular payment mandate that is to be created and may include this payment mandate identifier in the payment provider-independent payment mandate setup request.

The user interface portion implementing the checkout process may also provide affordances for the customer to select a payment provider (e.g., a credit card or debit card payment, a bank payment, a voucher payment, a specific mobile payment service, mobile carrier billing, and the like).

At 230, the electronic payment transaction platform 150 receives a payment provider identifier identifying a payment provider (e.g., a second payment provider 130B) from among a plurality of payment providers 130. This payment provider identifier may be provided as part of the payment mandate setup request received at 210 (accordingly, in some embodiments, the order of steps 220 and 230 may be switched).

At 240, the electronic payment transaction platform 150 transmits the payment provider-independent payment mandate setup request to the payment provider 130 identified by the payment provider identifier at 230 via the corresponding SPI 131, where, as noted above, the payment provider-independent payment mandate setup request may include a payment mandate identifier. The electronic payment transaction platform 150 automatically determines how to transmit the payment provider-independent payment mandate setup request based on the payment provider identifier. For example, in some embodiments, each of the payment providers 130 may make its corresponding SPI 131 accessible or available at a specified electronic address (e.g., uniform resource locator (URL) or uniform resource identifier (URI)), such that the electronic payment transaction platform 150 can transmit payment provider-independent payment mandate setup request to the specified address (e.g., transmit an HTTP POST message to the specified URI, where the payment provider-independent payment mandate setup request is provided as the body of the POST message). The messages transmitted from the electronic payment transaction platform 150 to the payment provider 130 via the SPI 131 may be cryptographically signed (e.g., with a private key of the electronic payment transaction platform 150) such that the payment provider 130 can authenticate (e.g., using a matching public key of the electronic payment transaction platform 150) the payment provider-independent payment mandate setup request (and thereby reduce fraud associated with fraudulent requests to setup payment mandates). Likewise, messages from the payment provider 283 back to the electronic payment transaction platform 150 may also be encrypted and/or cryptographically signed (e.g., using a public-private key pair associated with the payment provider 283), and messages between the merchant 282 and the electronic payment transaction platform 285 may similarly be encrypted and/or cryptographically signed using similar public-private key pairs (public-key cryptography).

In response to the payment provider-independent payment mandate setup request, the payment provider 130 determines whether to grant the payment mandate setup request. The details of the determination are specific to internal policies and procedures of the payment provider. Some aspects of the processes for making the determination include authenticating the customer identified by the customer identifier in the payment provider-independent payment mandate setup request (e.g., requesting that the customer log into the payment provider service and confirm the details of the payment mandate), sending a multi-factor authentication challenge to the customer identified by the customer identifier (e.g., sending a text message or requesting that the user enter a code shown in a mobile authentication application or insert a hardware security token). For example, the customer using a personal computing device such as a laptop computer or mobile phone or tablet may be redirected from the merchant website or the merchant app to a website operated by the payment provider (e.g., in a pop-up window), where a redirect URI 286A for the customer to accept the payment mandate is transmitted from the payment provider 283 to the electronic payment transaction platform 285, which provides the redirect URI 286B to the merchant 282, which can then redirect the customer (e.g., the web browser operated by the customer) to the URI specified by the payment provider 283. The customer may then be asked to log in or otherwise confirm a connection between the customer's account at the payment provider and the merchant (e.g., using an authorization protocol such as Open Authorization or OAuth) to accept the payment mandate at 287.

Some aspects of the processes for making this determination regarding whether to approve the payment mandate may include verifying that an account associated with the customer holds sufficient funds to commit to the payment mandate and/or that the customer has sufficient credit (or may be extended sufficient credit based on a creditworthiness analysis). As another example, in the case of a credit card payment, the electronic payment transaction platform 150 may provide support for credit card payments, and the payment provider may choose to delegate the credit card payment to the electronic payment transaction platform 150, and the electronic payment transaction platform 150 may perform analysis of the credit card, such as performing 3-D Secure (3DS) verification on the credit card, such as verifying that the customer authorized the request for a payment mandate. In some embodiments, after completing authentication or verification of the customer, the electronic payment transaction platform 150 transmits a delegation response to the payment provider (e.g., that the customer has been authenticated or that the authentication or verification process failed).

At 250, the electronic payment transaction platform 150 receives approval 287 of the payment mandate setup request from specified payment provider, where the approval includes the payment mandate identifier. (If a rejection of the payment mandate setup request was received from the specified payment provider, then the payment mandate setup process according to the method 200 may be aborted and an error message relating to the rejection of the payment mandate setup request may then be displayed to the customer.)

After receiving approval of the payment mandate from the payment provider 283, the electronic payment transaction platform 150 stores, at 260, a payment mandate for the customer of the merchant in association with the merchant and the payment provider, where the payment mandate is associated with the payment mandate identifier and where the payment mandate may be stored in a payment mandate data store 155 (e.g., a database). At 289, the customer computing device may be redirected back to the merchant's website or application (e.g., mobile app). In more detail, the payment mandate setup request 281 from the merchant may include a return uniform resource identifier (URI), which may also be provided to the payment provider 283 as part of the payment provider-independent payment mandate setup request 284. This return URI is provided back to the customer such that the customer is redirected back to the merchant's website or app (as identified by the return URI). In the example shown in FIG. 2B, the customer may be redirected to the merchant after logging in to the payment provider and after (or while) the payment provider performs its determination as to whether to accept the payment mandate.

In some circumstances, a payment may be made contemporaneously with setting up the payment mandate (e.g., an initial online payment) where the payment mandate is also stored for later use. For example, when signing up for a subscription service with periodic renewal, a customer may be immediately charged (online) for the first period and the payment mandate may be used to charge the customer (offline) for renewal of the subscription service. In such a case, the payment provider 283 may also immediately charge the customer when accepting the transaction.

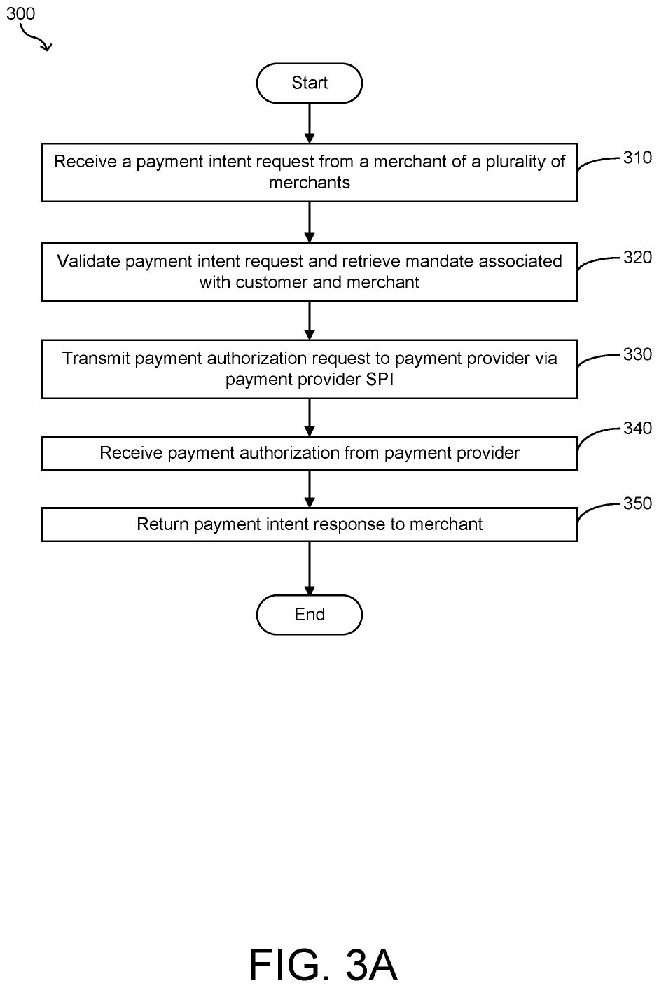

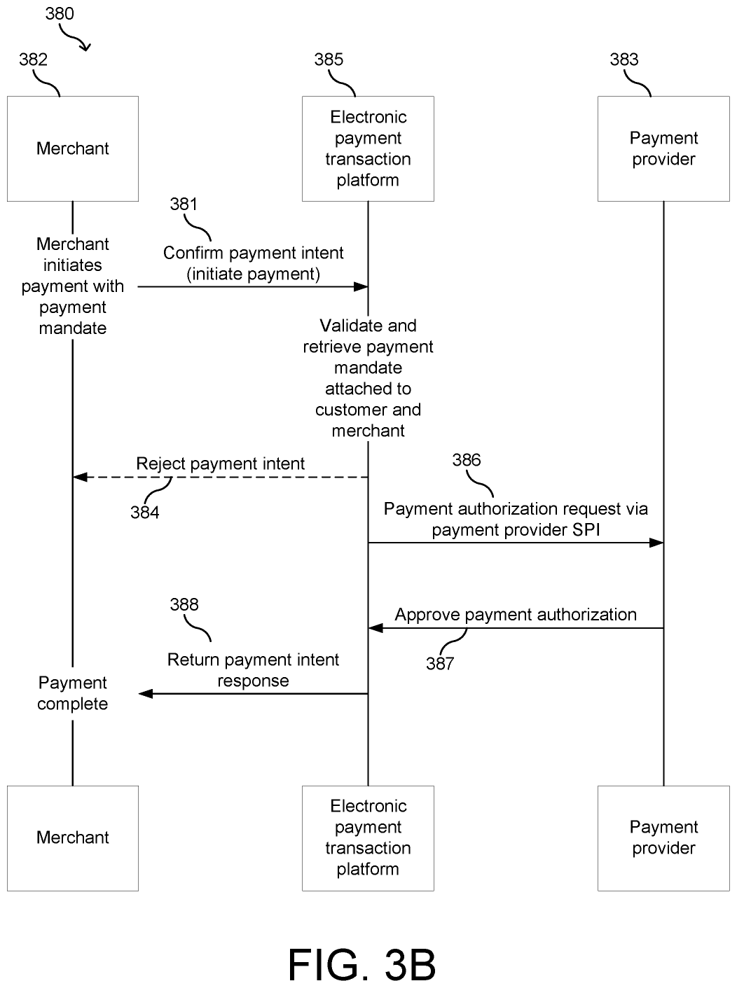

Later, the merchant associated with the payment mandate can retrieve the payment mandate from the payment mandate data store 155 initiate a payment from the customer to the merchant, as will be described in more detail below with respect to FIG. 3.

Accordingly, aspects of embodiments of the present disclosure relate to methods to automate creating payment mandates between customers and merchants in a manner that is independent of the payment provider used by the customer to pay the merchant as initiated by the merchants in accordance with the payment mandates. The processes described above are automatically performed by computer systems in response to engagements by consumers, merchants, and payment providers engaging in electronic commerce (e.g., internet commerce), which perform these operations in manners substantially different from manual interactions between customers, merchants, and financial institutions (e.g., banks and credit cards).

FIG. 3A is a flowchart depicting a method 300 for processing a payment mandate, according to one embodiment of the present disclosure. In various embodiments of the present disclosure, the method 300 and equivalents thereof are implemented using one or more processing circuits of computing system environments with software and hardware architectures such as those described below with respect to FIG. 5, FIG. 6, and FIG. 7.

FIG. 3B is a sequence diagram 380 depicting communications, according to one embodiment of the present disclosure, between a merchant 382, a payment provider 383, and an electronic payment transaction platform 385, when a merchant initiates a payment using a saved, existing payment mandate. FIG. 3B illustrates a sequence diagram that corresponds to the steps in the FIG. 3A flowchart. The steps of FIG. 3A will described together with FIG. 3B.

At 310, the electronic payment transaction platform 385 receives a confirm payment intent message 381 from a merchant 382, where the confirm payment intent message 381 corresponds to the merchant 382 attempting to initiate a payment from a customer using a saved payment mandate. The confirm payment intent message 381 may include, for example, identifying information such as a merchant identifier associated with the merchant, a customer identifier associated with the customer, and/or a payment mandate identifier, and may further include a payment amount. The merchant 382 may initiate this payment to charge for the automatic renewal of a subscription, to charge based on the delivery of previously promised goods and/or services, to charge for recently delivered goods or services (e.g., a trip taken through a rideshare service), and the like.

At 320, the electronic payment transaction platform 385 validates the received message (e.g., verifies a cryptographic signature of the message using a public key associated with the merchant 382) and retrieves the payment mandate stored in the payment mandate data store 155 based on, for example, the payment mandate identifier or a combination of the merchant identifier and the customer identifier.

In some embodiments, as part of the validation process, the electronic payment transaction platform 385 confirms that the customer identifier and merchant identifier of the payment mandate match the customer identifier and merchant identifier provided in the confirm payment intent message 381. In some embodiments, the electronic payment transaction platform 385 checks whether the payment mandate is active (e.g., has not been revoked) as part of the validation process and also performs validations regarding the payment method type, merchant identifier, and customer identifier.

If the validation fails, then an error message or rejection message 384 regarding the failure of the payment intent may be returned to the merchant 382.

In a case where validation succeeds, then at 330 the electronic payment transaction platform 385 transmits a payment provider-independent payment authorization request 386 to the payment provider 383 associated with the stored payment mandate via the payment provider SPI. In a manner like the payment provider-independent payment mandate setup request 284 described above with respect to FIG. 2A and FIG. 2B, the payment provider-independent payment authorization request follows a standardized format. The electronic payment transaction platform 385 would transmit substantially the same message to any given payment provider in accordance with the standardized format, where the message is customized to the details of the transaction (e.g., containing data such as the customer identifier, the merchant identifier, and the payment amount).

The payment provider 383 then determines whether to approve the payment provider-independent payment authorization request 386. This determination may be performed, for example, by checking an account balance or amount of credit of a customer account associated with the payment mandate, determining whether the account is still active (e.g., not closed through an explicit closure by the customer or frozen due to determination of fraudulent or criminal activity). The determination may also include checking whether the payment mandate has been revoked at the payment provider 383, but where the information regarding the revocation had not yet propagated to the electronic payment transaction platform 385 when it validated the payment mandate.

In response to the payment provider-independent payment authorization request 386, the payment provider 383 may approve the payment authorization and send a message 387 to the electronic payment transaction platform 385 accordingly or may reject the payment authorization and return an error message to the electronic payment transaction platform 385.

At 340, the electronic payment transaction platform 385 receives the payment authorization (or rejection) from the payment provider, and at 350 the electronic payment transaction platform 385 returns the payment intent response 388 to the merchant, which may either confirm successful execution of the payment that the merchant initiated or rejection of that payment.

Accordingly, aspects of embodiments of the present disclosure relate to merchant-initiated payments where an electronic payment transaction platform receives standardized requests for payment intents, automatically validates those payment requests based on stored information regarding the payment mandates between the merchants and their customers, and uses a standardized interface to interact with different payment providers to request approval and completion of the payment requests associated with various payment mandates.

As noted above, payment mandates can be revoked, at which point they would not be valid for use. Merchants 120 and payment providers 130 can revoke payment mandates, and the electronic payment transaction platform 150 coordinates the update of the information regarding the payment mandate as being revoked and the communication of the revocation of the payment mandate to other parties (e.g., the party that did not initiate the revocation of the payment mandate).

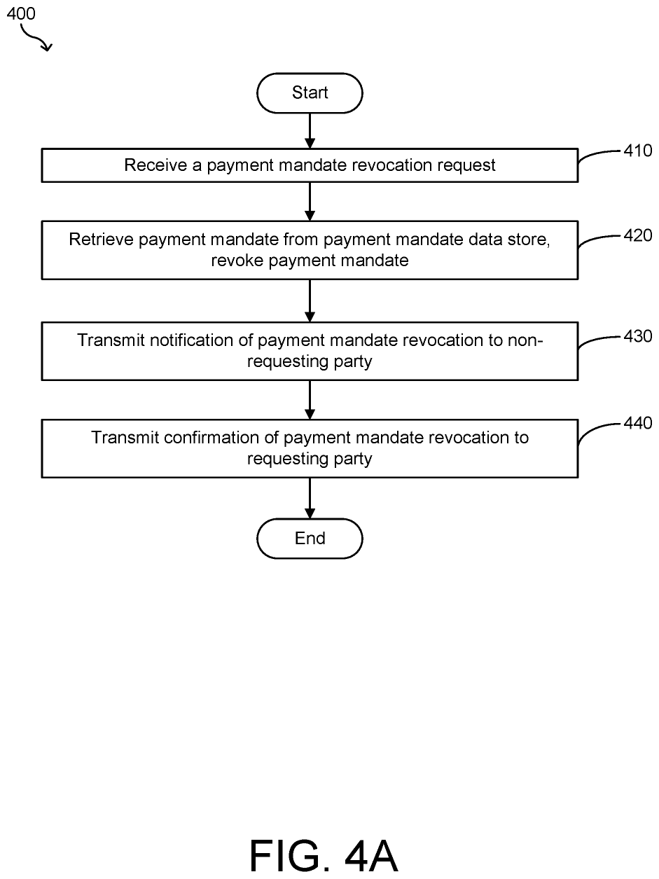

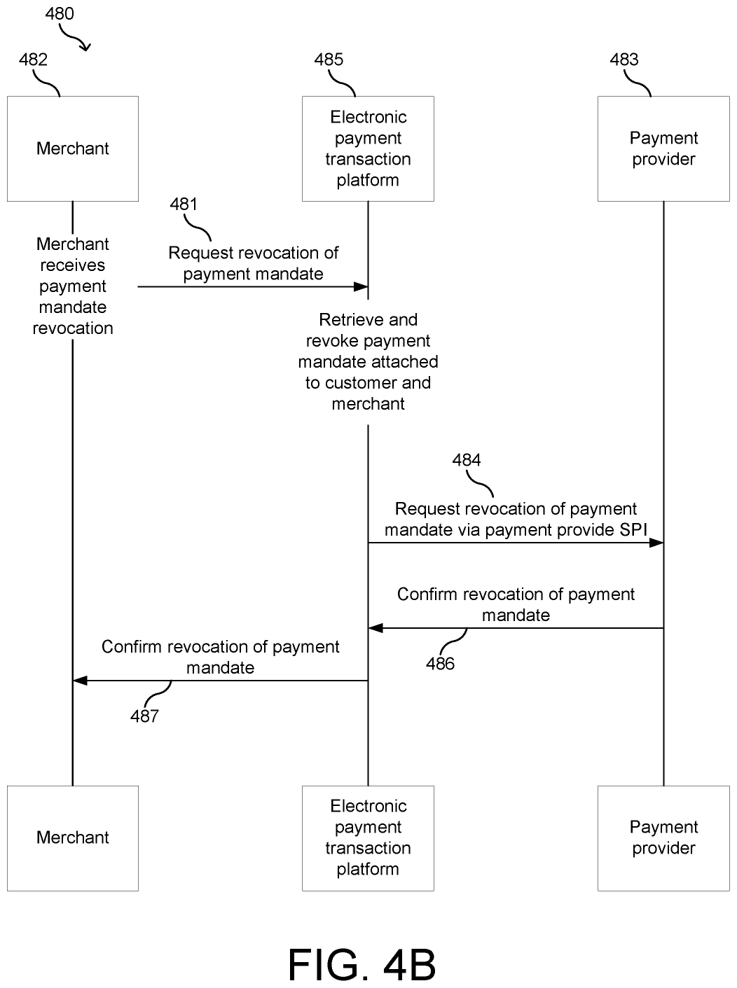

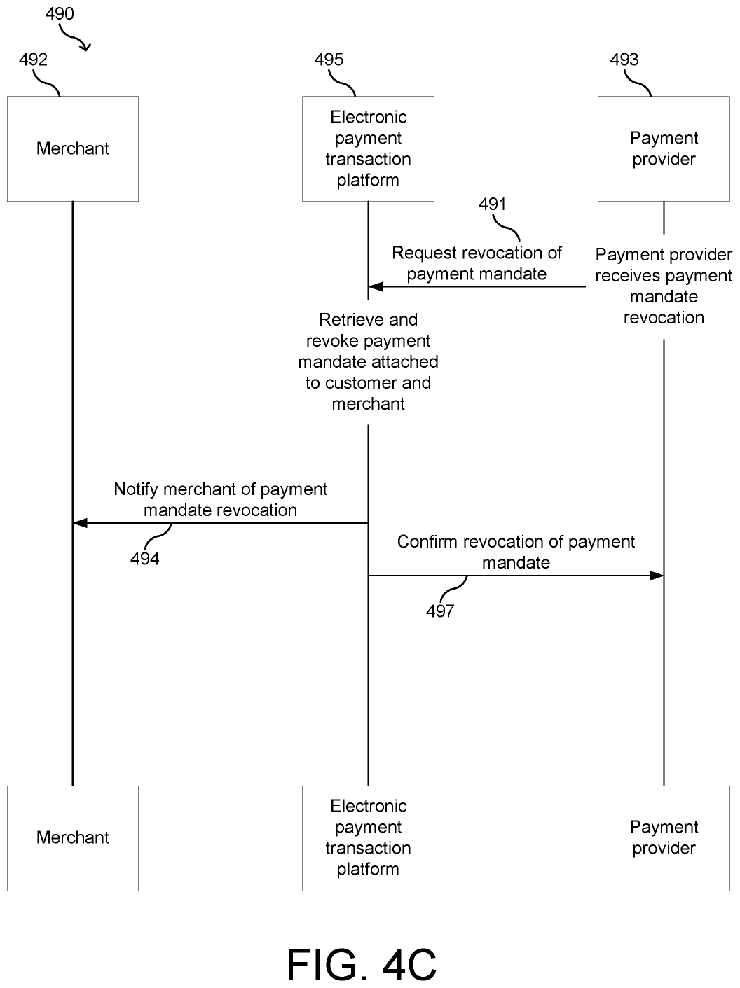

FIG. 4A is a flowchart depicting a method 400 for revoking a payment mandate, according to one embodiment of the present disclosure. In various embodiments of the present disclosure, the method 400 and equivalents thereof are implemented using one or more processing circuits of computing system environments with software and hardware architectures such as those described below with respect to FIG. 5, FIG. 6, and FIG. 7.

FIG. 4B is a sequence diagram 480 depicting communications, according to one embodiment of the present disclosure, between a merchant 482, an electronic payment transaction platform 485, and a payment provider 483 when a merchant 482 initiates a revocation of a payment mandate.

FIG. 4C is a sequence diagram 490 depicting communications, according to one embodiment of the present disclosure, between a merchant 492, an electronic payment transaction platform 495, and a payment provider 493 when a payment provider 493 initiates a revocation of a payment mandate. FIGS. 4B-4C illustrate sequence diagrams that corresponds to the steps in the FIG. 4A flowchart. The steps of FIG. 4A will described together with FIGS. 4B-4C.

At 410, the electronic payment transaction platform 150 receives a payment mandate revocation request from a requesting party. In various embodiments, the requesting party may be a merchant 482 as shown in FIG. 4B or a payment provider 493 as shown in FIG. 4C. The request 481 from the merchant 482 or the request 491 from the payment provider 493 may be triggered by a customer request, such as a customer request to the merchant 482 to cancel the goods or services to be provided in exchange for payments via the payment mandate or through a customer request to the payment provider 493 to cease allowing the merchant 492 to charge the customer using the payment mandate (e.g., this may be used by the customer in the case of a non-communicative merchant). The request from the merchant 482 may also be initiated by the merchant without customer input (e.g., the customer makes unreasonable demands on the merchant) or may be initiated by the payment provider without customer input (e.g., in the case of fraud, such as the unauthorized use of a customer account to create a payment mandate or in a case where the customer account has been closed or frozen).

At 420, the electronic payment transaction platform 150 retrieves the payment mandate identified in the payment mandate revocation request and revokes that payment mandate (e.g., by updating a field in the database indicating that the payment mandate is revoked and inactive). The revocation may cause causes future attempts to charge payments based on this payment mandate to fail validation, as discussed above with respect to FIG. 3.

At 430, the electronic payment transaction platform 150 transmits notification of the payment mandate revocation to the non-requesting party.

As shown in FIG. 4B where the merchant 482 was the requesting party, the electronic payment transaction platform 485 transmits a request 484 to revoke the payment mandate to the payment provider 483 (the non-requesting party), where the request may be sent via the standardized payment provider SPI. The payment provider 483 may then confirm revocation of the payment mandate 486 to the electronic payment transaction platform 485.

Similarly, as shown in FIG. 4C where the payment provider 493 was the requesting party, the electronic payment transaction platform 495 transmits a notification 494 to the merchant 492 (the non-requesting party) regarding the revocation of the payment mandate.

At 440, the electronic payment transaction platform 150 transmits confirmation of the payment mandate revocation to the requesting party. For example, as shown in FIG. 4B, the electronic payment transaction platform 485 transmits a confirmation of the revocation of the payment mandate 487 to the merchant 482 (the requesting party), and the merchant 482 may notify the customer of the revocation of this payment mandate.

Similarly, as shown in FIG. 4C, the electronic payment transaction platform 495 transmits a confirmation of the revocation of the payment mandate 497 to the payment provider 493 (the requesting party), and the payment provider 493 may notify the customer of the revocation of this payment mandate.

Accordingly, aspects of embodiments of the present disclosure relate to systems and methods for the consistent electronic implementation of payment mandates for merchant-initiated transactions across multiple different payment providers and for multiple different merchants. Aspects of embodiments of the present disclosure address the problem of delivering consistent payment mandate services to customers, regardless of the payment provider that the customer chooses to use for the payment mandate because the supported payment providers to comply with a standardized or uniform interface for setting up payment mandates (e.g., each of the payment providers 130 implements a uniform SPI 131).

The uniform SPI 131 implemented by the payment providers also reduces the implementation burden on engineering staff at the electronic payment transaction platform 150. Without the use of a uniform SPI 131, each payment provider 130 may expose a different set of application programming interfaces (APIs) that may provide different functionality or may provide similar functionality but use different terminology or be designed with different assumptions about customer and merchant behavior. Accordingly, developing code to implement a payment mandate with these varying APIs is time consuming and requires engineers of the electronic payment transaction platform 150 to become experts in the API exposed by each payment provider 130. As the number of payment providers grows (e.g., as the electronic payment transaction platform 150 expands into different geographic markets), this engineering burden increases. In contrast, engineers working for payment providers 130 are already familiar with their technology and therefore are well suited to developing an SPI 131 that complies with standards that are specified by the electronic payment transaction platform 150 or specified by a standards setting organization. These engineers can adapt or modify existing APIs to support the specified payment provider SPI and may also create new functionality to adapt to the expectations and assumptions made by the payment provider SPI. This reduces the overall engineering burden of connecting payment providers 130 to the electronic payment transaction platform 150 to support payment mandates and makes the integration of additional payment providers 130 economical, even for payment providers that serve relatively small markets. This further increases the reach of payment mandates to a larger number of customers, such as customers who rely on niche payment providers, and further enables merchants to reach those underserved customers.

Embodiments of the present disclosure implementing these programming interfaces, including the payment provider SPI 131, enable the fully automatic establishment of payment mandates and the processing of payments using these payment mandates, thereby increasing flexibility and improving the efficiency of electronic payment transactions. These standardized interfaces further improve the reliability of exercising payment mandates, as errors or bugs arising from misunderstandings or incompatibilities of different APIs exposed by payment providers are reduced or avoided. For example, the electronic payment transaction platform 150 may perform a certification process where automatic testing is performed on the payment provider SPI 131 implemented by a given payment provider 130 to verify compliance with workflows associated with payment mandates processed by the electronic payment transaction platform 150 (e.g., creation, invocation or use by merchants, and revocation).

With reference to FIG. 5, an example embodiment of a high-level SaaS network architecture 500 is shown. A networked system 516 provides server-side functionality via a network 510 (e.g., the Internet or a WAN) to a client device 508. A web client 502 and a programmatic client, in the example form of a client application 504 (e.g., client software for creating or invoking a payment mandate), are hosted and execute on the client device 508. The networked system 516 includes one or more servers 522 (e.g., servers hosting services exposing remote procedure call APIs), which hosts a processing system 506 (such as the processing system described above according to various embodiments of the present disclosure supporting service for automatically processing accounting data) that provides a number of functions and services via a service oriented architecture (SOA) and that exposes services to the client application 504 that accesses the networked system 516 where the services may correspond to particular workflows. The client application 504 also provides a number of interfaces described herein, which can present an output in accordance with the methods described herein to a user of the client device 508.

The client device 508 enables a user to access and interact with the networked system 516 and, ultimately, the processing system 506. For instance, the user provides input (e.g., touch screen input or alphanumeric input) to the client device 508, and the input is communicated to the networked system 516 via the network 510. In this instance, the networked system 516, in response to receiving the input from the user, communicates information back to the client device 508 via the network 510 to be presented to the user.

An API server 518 and a web server 520 are coupled, and provide programmatic and web interfaces respectively, to the servers 522. For example, the API server 518 and the web server 520 may produce messages (e.g., RPC calls) in response to inputs received via the network, where the messages are supplied as input messages to workflows orchestrated by the processing system 506. The API server 518 and the web server 520 may also receive return values (return messages) from the processing system 506 and return results to calling parties (e.g., web clients 502 and client applications 504 running on client devices 508 and third-party applications 514) via the network 510. The servers 522 host the processing system 506, which includes components or applications in accordance with embodiments of the present disclosure as described above. The servers 522 are, in turn, shown to be coupled to one or more database servers 524 that facilitate access to information storage repositories (e.g., databases 526). In an example embodiment, the databases 526 includes storage devices that store information accessed and generated by the processing system 506, such as the payment mandate data store 155 of FIG. 1 and other databases such as databases storing information associated with transactions processed by a business.

Additionally, a third-party application 514, executing on one or more third-party servers 521, is shown as having programmatic access to the networked system 516 via the programmatic interface provided by the API server 518. For example, the third-party application 514, using information retrieved from the networked system 516, may support one or more features or functions on a website hosted by a third-party. For example, the third-party application 514 may include the SPIs 131 implemented by the payment providers 130 and may also include applications that access the payment provider API 151 shown in FIG. 1.

Turning now specifically to the applications hosted by the client device 508, the web client 502 may access the various systems (e.g., the processing system 506) via the web interface supported by the web server 520. Similarly, the client application 504 (e.g., an “app” such as an electronic commerce website or standalone app) may access the various services and functions provided by the processing system 506 via the programmatic interface provided by the API server 518. The client application 504 may be, for example, an “app” executing on the client device 508, such as an iOS or Android OS application to enable a user to access and input data on the networked system 516 in an offline manner and to perform batch-mode communications between the client application 504 and the networked system 516.

Further, while the network architecture 500 shown in FIG. 5 employs a client-server architecture, the present disclosure is not limited to such an architecture, and could equally well find application in a distributed, or peer-to-peer, architecture system, for example.

FIG. 6 is a block diagram illustrating an example software architecture 606, which may be used in conjunction with various hardware architectures herein described. FIG. 6 is a non-limiting example of a software architecture 606, and it will be appreciated that many other architectures may be implemented to facilitate the functionality described herein. The software architecture 606 may execute on hardware such as a machine 700 of FIG. 7 that includes, among other things, processors 704, memory/storage 706, and input/output (I/O) components 718. A representative hardware layer 652 is illustrated and can represent, for example, the machine 700 of FIG. 7. The representative hardware layer 652 includes a processor 654 having associated executable instructions 604. The executable instructions 604 represent the executable instructions of the software architecture 606, including implementation of the methods, components, and so forth described herein. The hardware layer 652 also includes non-transitory memory and/or storage modules as memory/storage 656, which also have the executable instructions 604. The hardware layer 652 may also include other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616 (such as the services of the processing system), and a presentation layer 614. Operationally, the applications 616 and/or other components within the layers may invoke API calls 608 through the software stack and receive a response as messages 612 in response to the API calls 608. The layers illustrated are representative in nature, and not all software architectures have all layers. For example, some mobile or special-purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than by interfacing directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 620 may also include a wide variety of other libraries 648 to provide many other APIs to the applications 616 and other software components/modules.

The frameworks/middleware 618 provide a higher-level common infrastructure that may be used by the applications 616 and/or other software components/modules. For example, the frameworks/middleware 618 may provide high-level resource management functions, web application frameworks, application runtimes 642 (e.g., a Java virtual machine or JVM), and so forth. The frameworks/middleware 618 may provide a broad spectrum of other APIs that may be utilized by the applications 616 and/or other software components/modules, some of which may be specific to a particular operating system or platform.

The applications 616 include built-in applications 638 and/or third-party applications 640. The applications 616 may use built-in operating system functions (e.g., kernel 622, services 624, and/or drivers 626), libraries 620, and frameworks/middleware 618 to create user interfaces to interact with users of the system. Alternatively, or additionally, in some systems, interactions with a user may occur through a presentation layer, such as the presentation layer 614. In these systems, the application/component “logic” can be separated from the aspects of the application/component that interact with a user.

Some software architectures use virtual machines. In the example of FIG. 6, this is illustrated by a virtual machine 610. The virtual machine 610 creates a software environment where applications/components can execute as if they were executing on a hardware machine (such as the machine 700 of FIG. 7, for example). The virtual machine 610 is hosted by a host operating system (e.g., the operating system 602 in FIG. 6) and typically, although not always, has a virtual machine monitor 660 (or hypervisor), which manages the operation of the virtual machine 610 as well as the interface with the host operating system (e.g., the operating system 602). A software architecture executes within the virtual machine 610 such as an operating system (OS) 636, libraries 634, frameworks 632, applications 630, and/or a presentation layer 628. These layers of software architecture executing within the virtual machine 610 can be the same as corresponding layers previously described or may be different.

Some software architectures use containers 670 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 670 is similar to a virtual machine in that it includes a software architecture including libraries 634, frameworks 632, applications 630, and/or a presentation layer 628, but omits an operating system and, instead, communicates with the underlying host operating system 602.

FIG. 7 is a block diagram illustrating components of a machine 700, according to some example embodiments, able to read instructions from a non-transitory machine-readable medium (e.g., a computer-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or in parallel or concurrently, that specify actions to be taken by the machine 700. Further, while only a single machine 700 is illustrated, the term “machine” or “processing circuit” shall also be taken to include a collection of machines that individually or jointly execute the instructions 710 to perform any one or more of the methodologies discussed herein.

The machine 700 may include processors 704 (including processors 708 and 712), memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of the processors 704 are examples of machine-readable media.

The I/O components 718 may include a wide variety of components to receive input, provide output, produce output, transmit information, exchange information, capture measurements, and so on. The specific I/O components 718 that are included in a particular machine will depend on the type of machine. For example, portable machines such as mobile phones may include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion, and the grouping is in no way limiting. In various example embodiments, the I/O components 718 may include output components 726 and input components 728. The output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environment components 736, or position components 738, among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 738 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via a coupling 724 and a coupling 722, respectively. For example, the communication components 740 may include a network interface component or other suitable device to interface with the network 732. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

According to one embodiment of the present disclosure, a system includes: a processing circuit; and memory storing instructions that, when executed by processing devices include the processing circuit, cause the processing devices to: receive a payment mandate setup request from a merchant of a plurality of merchants; create a payment provider-independent payment mandate setup request based on the payment mandate setup request; receive a payment provider identifier identifying a payment provider from among a plurality of payment providers; transmit the payment provider-independent payment mandate setup request to the payment provider identified by the payment provider identifier, the payment provider-independent payment mandate setup request include a payment mandate identifier; receive approval of the payment mandate setup request from specified payment provider, the approval include the payment mandate identifier; and store a payment mandate for a customer of the merchant in association with the merchant and the payment provider, the payment mandate being associated with the payment mandate identifier.

The system may further include memory storing instructions that, when executed by the processing devices, cause the processing devices to: receive, from the merchant, a payment intent request associated with the customer; retrieve the payment mandate for the customer of the merchant from a payment mandate data store; and in response to successfully retrieving the payment mandate, transmit a payment authorization request to the payment provider associated with the payment mandate.

The system may further include memory storing instructions that, when executed by the processing devices, cause the processing devices to: receive a revocation request for the payment mandate; and update the payment mandate in a payment mandate data store to indicate that the payment mandate is revoked.

The revocation request may be received from the merchant, and the system may further include memory storing instructions that, when executed by the processing devices, cause the processing devices to transmit a message to the payment provider indicating revocation of the payment mandate.

The revocation request may be received from the payment provider, and the system may further include instructions that, when executed by the processing devices, cause the processing devices to transmit a message to the merchant indicating revocation of the payment mandate.

The system may further include memory storing instructions that, when executed by the processing devices, cause the processing devices to: receive, from the merchant, a payment intent request associated with the customer; determine, the payment mandate in the payment mandate data store is revoked; and transmit a response to the merchant indicating that the payment intent request is rejected.

The system may further include memory storing instructions that, when executed by the processing devices, cause the processing devices to receive a delegation request from the payment provider to delegate the payment mandate, the delegation request include the payment mandate identifier.

The system may further include memory storing instructions that, when executed by the processing devices, cause the processing devices to: authenticate the customer; and transmit a delegation response to the payment provider that the customer has been authenticated.

The payment provider-independent payment mandate setup request may include a return uniform resource identifier (URI) configured by the merchant.

According to one embodiment of the present disclosure, a method includes: receiving a payment mandate setup request from a merchant of a plurality of merchants; creating, by a computer system include a processing circuit, a payment provider-independent payment mandate setup request based on the payment mandate setup request; receiving a payment provider identifier identifying a payment provider from among a plurality of payment providers; transmitting, by the computer system, the payment provider-independent payment mandate setup request to the payment provider identified by the payment provider identifier, the payment provider-independent payment mandate setup request include a payment mandate identifier; receiving approval of the payment mandate setup request from specified payment provider, the approval include the payment mandate identifier; and storing a payment mandate for a customer of the merchant in association with the merchant and the payment provider, the payment mandate being associated with the payment mandate identifier.

The method may further include: receiving, from the merchant, a payment intent request associated with the customer; retrieving the payment mandate for the customer of the merchant from a payment mandate data store; and in response to successfully retrieving the payment mandate, transmitting a payment authorization request to the payment provider associated with the payment mandate.

The method may further include: receiving a revocation request for the payment mandate; and updating the payment mandate in a payment mandate data store to indicate that the payment mandate is revoked.

The method may further include: receiving, from the merchant, a payment intent request associated with the customer; determining the payment mandate in the payment mandate data store is revoked; and transmitting a response to the merchant indicating that the payment intent request is rejected.

The payment provider-independent mandate setup request may include a return uniform resource identifier (URI) configured by the merchant.

According to one embodiment of the present disclosure, a non-transitory computer-readable medium stores instructions that, when executed, cause a computer system include a processing circuit to: receive a payment intent request from a merchant in association with a payment mandate between the merchant and a customer; retrieve the payment mandate from a payment mandate data store; validate the payment mandate; and in response to determining that the payment mandate is valid, transmit a payment provider-independent payment authorization request to a payment provider associated with the payment mandate.

The instructions to validate the payment mandate may include instructions to determine whether the payment mandate is revoked.

The non-transitory computer-readable medium may further store instructions that, when executed, cause the computer system to: receive a revocation request for the payment mandate; and update the payment mandate in the payment mandate data store to indicate that the payment mandate is revoked.

The non-transitory computer-readable medium may further store instructions that, when executed, cause the computer system to: receive, from the merchant, a payment intent request associated with the customer; determine the payment mandate in the payment mandate data store is revoked; and transmit a response to the merchant indicating that the payment intent request is rejected.

The revocation request may be received from the merchant.

The non-transitory computer-readable medium may further include transmitting a message to the payment provider indicating revocation of the payment mandate.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system comprising:
a processing circuit; and
memory storing instructions that, when executed by processing devices comprising the processing circuit, cause the processing devices to:
receive a payment mandate setup request from a merchant of a plurality of merchants;
create a payment provider-independent payment mandate setup request based on the payment mandate setup request;
receive a payment provider identifier identifying a payment provider from among a plurality of payment providers;
transmit the payment provider-independent payment mandate setup request to the payment provider identified by the payment provider identifier, the payment provider-independent payment mandate setup request comprising a payment mandate identifier;
receive approval of the payment mandate setup request from specified payment provider, the approval comprising the payment mandate identifier; and
store a payment mandate for a customer of the merchant in association with the merchant and the payment provider, the payment mandate being associated with the payment mandate identifier.

2. The system of claim 1, further comprising memory storing instructions that, when executed by the processing devices, cause the processing devices to:
receive, from the merchant, a payment intent request associated with the customer;
retrieve the payment mandate for the customer of the merchant from a payment mandate data store; and
in response to successfully retrieving the payment mandate, transmit a payment authorization request to the payment provider associated with the payment mandate.

3. The system of claim 1, further comprising memory storing instructions that, when executed by the processing devices, cause the processing devices to:
receive a revocation request for the payment mandate; and
update the payment mandate in a payment mandate data store to indicate that the payment mandate is revoked.

4. The system of claim 3, wherein the revocation request is received from the merchant, and
further comprising memory storing instructions that, when executed by the processing devices, cause the processing devices to transmit a message to the payment provider indicating revocation of the payment mandate.

5. The system of claim 3, wherein the revocation request is received from the payment provider, and
further comprising instructions that, when executed by the processing devices, cause the processing devices to transmit a message to the merchant indicating revocation of the payment mandate.

6. The system of claim 3, further comprising memory storing instructions that, when executed by the processing devices, cause the processing devices to:
receive, from the merchant, a payment intent request associated with the customer;
determine, the payment mandate in the payment mandate data store is revoked; and
transmit a response to the merchant indicating that the payment intent request is rejected.

7. The system of claim 3, further comprising memory storing instructions that, when executed by the processing devices, cause the processing devices to receive a delegation request from the payment provider to delegate the payment mandate, the delegation request comprising the payment mandate identifier.

8. The system of claim 7, further comprising memory storing instructions that, when executed by the processing devices, cause the processing devices to:
authenticate the customer; and
transmit a delegation response to the payment provider that the customer has been authenticated.

9. The system of claim 1, wherein the payment provider-independent payment mandate setup request comprises a return uniform resource identifier (URI) configured by the merchant.

10. A method comprising:
receiving a payment mandate setup request from a merchant of a plurality of merchants;
creating, by a computer system comprising a processing circuit, a payment provider-independent payment mandate setup request based on the payment mandate setup request;
receiving a payment provider identifier identifying a payment provider from among a plurality of payment providers;
transmitting, by the computer system, the payment provider-independent payment mandate setup request to the payment provider identified by the payment provider identifier, the payment provider-independent payment mandate setup request comprising a payment mandate identifier;
receiving approval of the payment mandate setup request from specified payment provider, the approval comprising the payment mandate identifier; and
storing a payment mandate for a customer of the merchant in association with the merchant and the payment provider, the payment mandate being associated with the payment mandate identifier.

11. The method of claim 10, further comprising:
receiving, from the merchant, a payment intent request associated with the customer;
retrieving the payment mandate for the customer of the merchant from a payment mandate data store; and
in response to successfully retrieving the payment mandate, transmitting a payment authorization request to the payment provider associated with the payment mandate.

12. The method of claim 10, further comprising:
receiving a revocation request for the payment mandate; and
updating the payment mandate in a payment mandate data store to indicate that the payment mandate is revoked.

13. The method of claim 12, further comprising:
receiving, from the merchant, a payment intent request associated with the customer;
determining the payment mandate in the payment mandate data store is revoked; and
transmitting a response to the merchant indicating that the payment intent request is rejected.

14. The method of claim 10, wherein the payment provider-independent mandate setup request comprises a return uniform resource identifier (URI) configured by the merchant.

15. A non-transitory computer-readable medium storing instructions that, when executed, cause a computer system comprising a processing circuit to:
receive a payment intent request from a merchant in association with a payment mandate between the merchant and a customer;
retrieve the payment mandate from a payment mandate data store;
validate the payment mandate; and
in response to determining that the payment mandate is valid, transmit a payment provider-independent payment authorization request to a payment provider associated with the payment mandate.

16. The non-transitory computer-readable medium of claim 15, wherein the instructions to validate the payment mandate comprise instructions to determine whether the payment mandate is revoked.

17. The non-transitory computer-readable medium of claim 15, further storing instructions that, when executed, cause the computer system to:
receive a revocation request for the payment mandate; and
update the payment mandate in the payment mandate data store to indicate that the payment mandate is revoked.

18. The non-transitory computer-readable medium of claim 17, further storing instructions that, when executed, cause the computer system to:
receive, from the merchant, a payment intent request associated with the customer;
determine the payment mandate in the payment mandate data store is revoked; and
transmit a response to the merchant indicating that the payment intent request is rejected.

19. The non-transitory computer-readable medium of claim 17, wherein the revocation request is received from the merchant.

20. The non-transitory computer-readable medium of claim 19, further comprising transmitting a message to the payment provider indicating revocation of the payment mandate.
